(19) United States
(12) Patent Application Publication
(10) Pub. No.: US 2012/0136900 A1
(43) Pub. Date: May 31, 2012

(54) SYSTEM AND METHOD FOR MANAGING DYNAMIC DIGITAL COMMUNITY BASED ON LOCATION AND SOCIAL RELATION

(75) Inventors: Hoon Ki Lee, Daejeon (KR); Jong-Hoon Lee, Daejeon (KR); Jung Tae Kim, Daejeon (KR); Euihyun Paik, Daejeon (KR)

(73) Assignee: Electronics and Telecommunications Research Institute, Daejeon (KR)

(21) Appl. No.: 13/304,080

(22) Filed: Nov. 23, 2011

(30) Foreign Application Priority Data
Nov. 26, 2010 (KR) 10-2010-0118467

(51) Int. Cl. G06F 17/30

(52) U.S. Cl. 707/784; 707/E17.059

(57) ABSTRACT

A system for managing a dynamic digital community based on location and social relations includes a user location information collecting block configured to analyze user location information and provide a location searching function of searching for where the user terminal is. Further, the system includes a community lifecycle management block configured to provide a service for creating and deleting a digital community, a service for joining a digital community as a member and withdrawing from the digital community, and a community execution service to user terminals; and a digital community profile database configured to store community profiles about respective digital communities. Furthermore, the system includes a user profile database configured to store user profiles of respective members who join the respective digital communities and creators of the respective digital communities; and a member management block configured to manage information of the respective members who join the respective digital communities.

### CROSS-REFERENCE TO RELATED APPLICATION(S)

The present invention claims priority of Korean Patent Application No. 10-2010-0118467, filed on Nov. 26, 2010, which is incorporated herein by reference.

### FIELD OF THE INVENTION

The present invention relates to a technique of managing a digital community such as cafe, blog and the like; and more particularly, to a system and method for managing digital community based on location and social relation, which is suitable to establish a dynamic digital community based on location/social relation in social network service environment and to allow a user to search for desired information.

### BACKGROUND OF THE INVENTION

As well known in the art, in online space such as internet, a café, a blog, and the like are serviced to users by which a user creates a desired group (community) and which an establisher who establishes the group provides join/withdraw service as being defined to the users. In the online community, subscribers (or members) maintain membership after joining until he/she withdraws from the online community.

Thus, users may be provided with online community services such as to share information with other subscribers, search for information such as sports-related information, politics-related information, avocation-related information, interest-related information, restaurant-related information, and map information, and/or to share solution of trouble after joining the online community created by the establisher using mobile terminals which the users carry.

However, in accordance with existing management method for an online community, it is inconvenient for a user to frequently join an online community such as a cafe, blog, and the like for acquisition of desired information. Moreover, online communities need to be frequently opened for establishing relationship between various persons according to features of a location where users are by considering relation related to the location, and inconvenient procedures for authenticating users' join/withdraw need to be provided to users who do not subscribed yet.

In addition, the existing management method of an online community has restrictions of accessing an already opened community and of opening a new community and is not performed in real time.

### SUMMARY OF THE INVENTION

In view of the above, the present invention provides a system and method for managing digital community based on location and social relation, which is suitable to establish a dynamic digital community based on location/social relation in social network service environment and to allow a user to search for desired information.

The present invention is not limited thereto, but and other objects that are not described above will be apparently understood by those skilled in the art from the following description.

In accordance with a first aspect of the present invention, there is provided a system for managing a dynamic digital community based on location and social relations. The system includes a user location information collecting block configured to analyze user location information provided by a user terminal and provide a location searching function of searching for where the user terminal is. Further, the system includes a community lifecycle management block configured to provide a service for creating and deleting a digital community, a service for joining a digital community as a member and withdrawing from the digital community, and a community execution service to user terminals based on the user profile and the user location information that are provided by the user location information collecting block; and a digital community profile database configured to store community profiles about respective digital communities that are created by the community lifecycle management block. Furthermore, the system includes a user profile database configured to store user profiles of respective members who join the respective digital communities that are registered in the digital community profile database and creators of the respective digital communities; and a member management block configured to manage information of the respective members who join the respective digital communities registered in the digital community profile database.

In accordance with a second aspect of the present invention, there is provided a method for managing a dynamic digital community based on location and social relations. The method includes providing a user profile and user location information to a community management server by a user terminal to request for creation of a digital community; and requesting the user terminal for input of community creation information for creating the digital community. Furthermore, the method includes building a profile database of a new digital community based on the community creation information that is provided from the user terminal and registering a new digital community which a user may search for and join in a community list; and providing a community execution service with respect to the newly registered digital community.

In accordance with a third aspect of the present invention, there is provided a method for managing a dynamic digital community based on location and social relations. The method includes requesting a community management server for searching a digital community related to a location by providing user location information and a keyword from a user terminal to the community management server. Further, the method includes searching a digital community profile database for the digital community related to the keyword and providing the searched result to the user terminal; and determining joining in at least one digital community included in the searched result by the user terminal and providing a user profile to the community management server from the user terminal. Furthermore, the method includes allowing the user terminal as a member, of the digital community in which the user terminal determines to join by reconstructing the digital community in which the user terminal determines to join by reconstructing a database of members of the digital community in which user terminal determines to join and updating information on a newly joined member. Further, the method includes providing a community execution service to the user terminal which newly joined as a member of the digital community in which user terminal determines to join.

In accordance with the present invention, the user terminal requests for creation of a digital community by providing the user profile, the user location information, and the community creation information to the community management server, a profile database of, a new digital community is built based on information on the creation of the digital community to generate the new digital community in a community list which a user searches for and joins in real time such that location and social related users participate in registered digital communities as members to receive an community execution service in real time. The users may be easily provided with services for creation of a digital community and join/withdrawal in/from a digital community in real time.

Moreover, a user may be provided with service sharing information, effectively and in real time, with several members who transmit and receive information in real time using several information such as location relation, social relation, and personal feature of a user in real time through a virtual space.

### BRIEF DESCRIPTION OF THE DRAWINGS

The objects and features of the present invention will become apparent from the following description of embodiments given in conjunction with the accompanying drawings, in which:

FIG. 1 is a block diagram illustrating a dynamic digital community managing system based on location and social relation in accordance with an embodiment of the present invention;

FIG. 2 is a view showing an example of a user profile screen to be serviced in accordance with the embodiment of the present invention;

FIG. 3 is a view illustrating schema structure of community profile database in accordance with the embodiment of the present invention;

FIG. 4 is a view illustrating classification system for digital communities provided in the embodiment of the present invention;

FIG. 5A is a view illustrating a menu screen providing a user interface for creation, modification, and deletion of a dynamic digital community in accordance with the embodiment of the present invention;

FIG. 5B is a view illustrating a menu screen providing a user interface for participation and withdrawal to and from a dynamic digital community in accordance with the embodiment of the present invention;

FIG. 6 is a flow chart illustrating process of creating a dynamic digital community in accordance with an embodiment of the present invention; and

FIG. 7 is a flow chart illustrating a main process of joining a created dynamic digital community as a member in accordance with an embodiment of the present invention.

### DETAILED DESCRIPTION OF THE EMBODIMENTS

Embodiments of the present invention will be described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

In the following description of the present invention, if the detailed description of the already known structure and operation may confuse the subject matter of the present invention, the detailed description thereof will be omitted. The following terms are terminologies defined by considering functions in the embodiments of the present invention and may be changed operators intend for the invention and practice. Hence, the terms should be defined throughout the description of the present invention.

Combinations of each step in respective blocks of block diagrams and a sequence diagram attached herein may be carried out by computer program instructions. Since the computer program instructions may be loaded in processors of a general purpose computer, a special purpose computer, or other programmable data processing apparatus, the instructions, carried out by the processor of the computer or other programmable data processing apparatus, create devices for performing functions described in the respective blocks of the block diagrams or in the respective steps of the sequence diagram.

Since the computer program instructions, in order to implement functions in specific manner, may be stored in a memory useable or readable by a computer aiming for a computer or other programmable data processing apparatus, the instruction stored in the memory useable or readable by a computer may produce manufacturing items including an instruction device for performing functions described in the respective blocks of the block diagrams and in the respective steps of the sequence diagram. Since the computer program instructions may be loaded in a computer or other programmable data processing apparatus, instructions, a series of processing steps of which is executed in a computer or other programmable data processing apparatus to create processes executed by a computer so as to operate a computer or other programmable data processing apparatus, may provide steps for executing functions described in the respective blocks of the block diagrams and the respective sequences of the sequence diagram.

Moreover, the respective blocks or the respective sequences may indicate modules, segments, or some of codes including at least one executable instruction for executing a specific logical function(s). In several alternative embodiments, is noticed that functions described in the blocks or the sequences may run out of order. For example, two successive blocks and sequences may be substantially executed simultaneously or often in reverse order according to corresponding functions.

Hereinafter, an embodiment of the present invention will be described in detail with the accompanying drawings which form a part hereof.

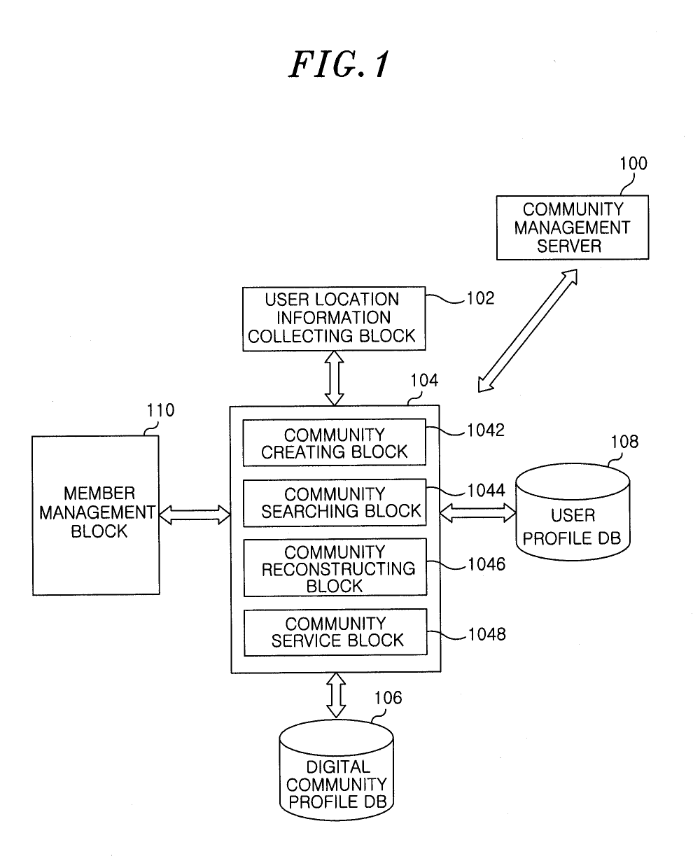

FIG. 1 is a block diagram illustrating a dynamic digital community managing system based on location and social relation in accordance with an embodiment of the present invention. The management system includes a user location information collecting block 102, a community lifecycle management block 104, a digital community profile database (DB) 106, a user profile database (DB) 108, and a member management block 110. Here, a reference numeral 100 may be assigned to a community management server.

Referring to FIG. 1, the user location information collecting block 102 provides a function of analyzing user location information provided from a user terminal, such as a GPS value or an IP value of a wireless LAN with which a user terminal accesses and a location searching function of searching for where the user terminal is. This user location information collecting may be performed through wired/wireless communication network such as GPS, WiFi, and the like. Here, the location searching function may be used as primary data for searching for regional features and/or event information that is provided by a region in order to provide services to the users.

Next the community lifecycle management block 104 provides a dynamic digital community management service based on location/social relation to a plurality of users, for example, in social network service (SNS) environment. The community lifecycle management block 104 provides functions of creating, deleting, participating to (joining), and withdrawing from a digital community (for example, a cafe, a blog, and the like) and a community performing service such as a chatting service, a video chatting service, a location searching service, and the like, to user terminals, based on a user profile and user location information that are provided through the user location information collecting block 102. The community lifecycle management block 104 includes a community creating block 1042, a community searching block 1044, a community reconstructing block 1046, and a community service block 1048.

First, the community creating block 1042 provides a function of creating a digital community having a user terminal as a community creator based on a user profile and user location information provided by a certain user terminal and stored in the user profile database 108 and of registering the created digital community in a community list (generating a digital community table). The community profiles about respective created digital communities are stored in the digital community profile DB 106. At this time, when a new digital community is created, an information resetting job in which a community table including creator information and information on members of the digital community is generated in a corresponding database is carried out. The information resetting job includes creation of a data structure and creation of a related database for storing and managing information of new members.

To this end, the digital community profile DB 106 stores the community profiles about the respective digital communities created by the community creating block 1042 and the user profile database (DB) 108 stores user profiles about the respective members joined with the respective digital communities and the community creators which are registered in the digital community profile DB 106.

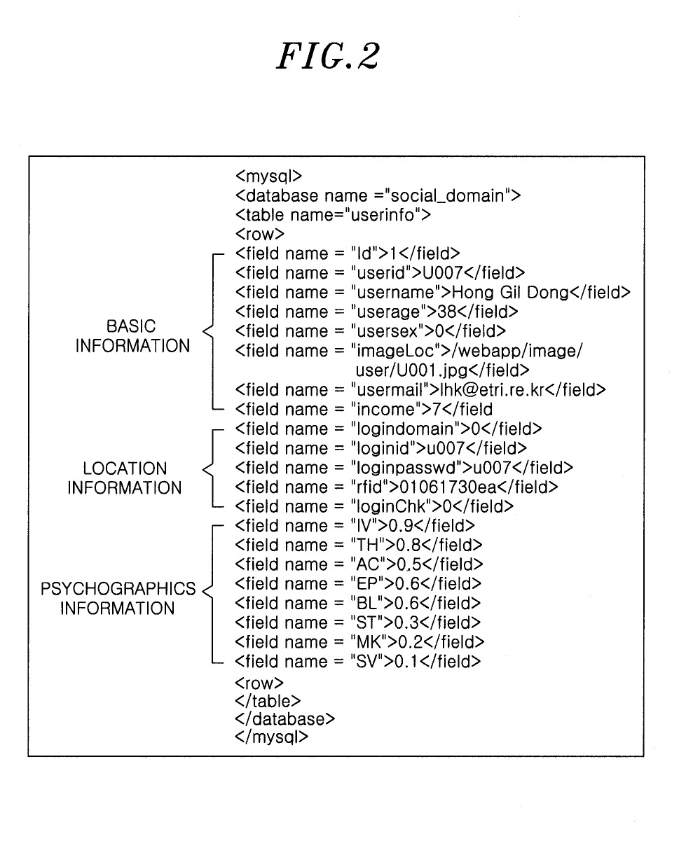

The user profile stored in the user profile DB 108 includes demographic information such as gender, age, avocation, and taste and psychographics information such as behavior, worth, preference, and taste. The user profile may be configured, for example, as illustrated in FIG. 2. Information managed by digitalizing the demographics information and the psychographics information may be commonly named “personal feature”.

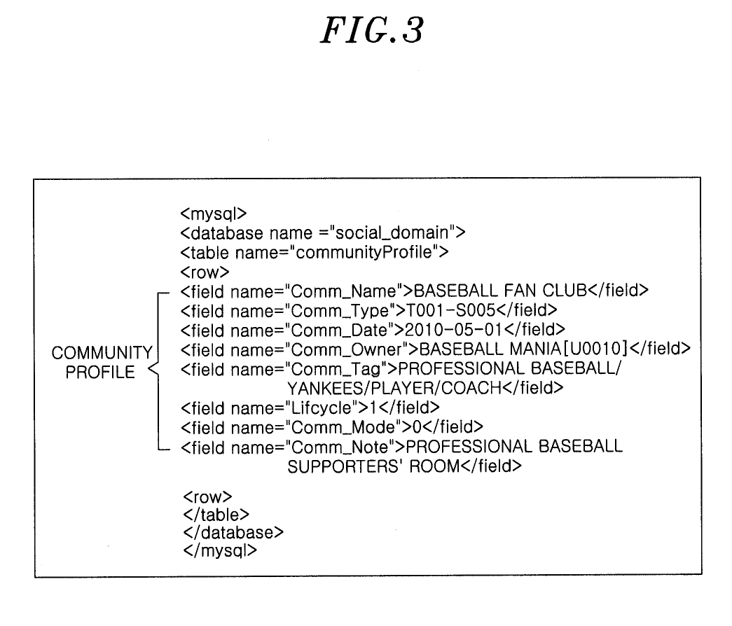

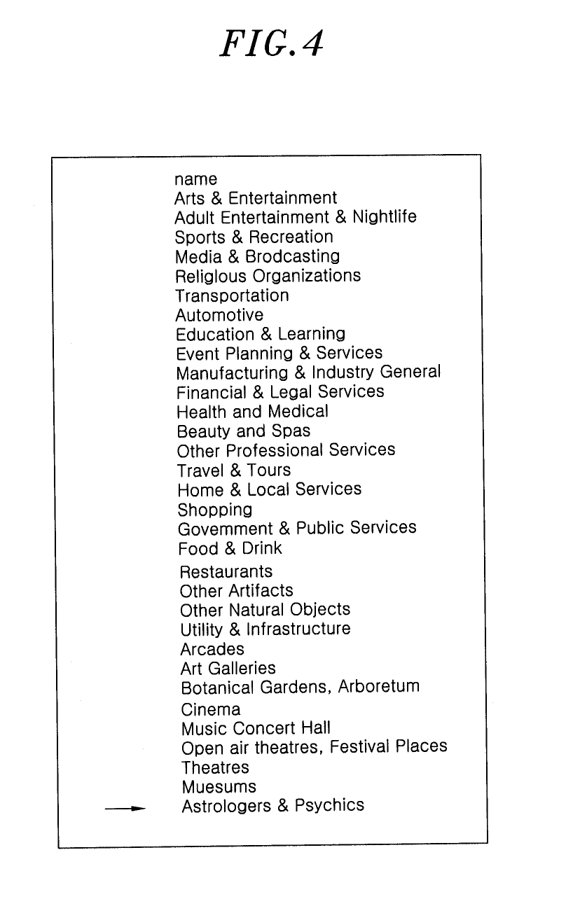

Database schema for managing the dynamic digital community, as illustrated in FIG. 3, includes eight field information, wherein a code value necessary for a classification system of the digital community is inputted in a “Comm_Type” field of the fields. This classification system, as illustrated in FIG. 4, is given based on a service domain that is provided by the digital community.

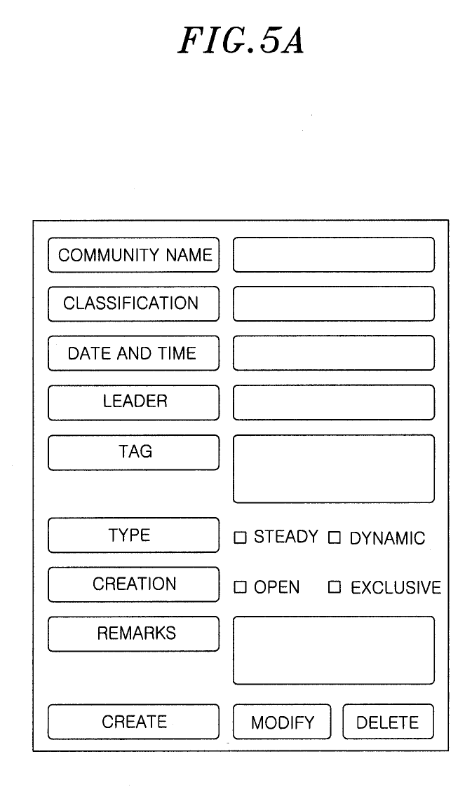

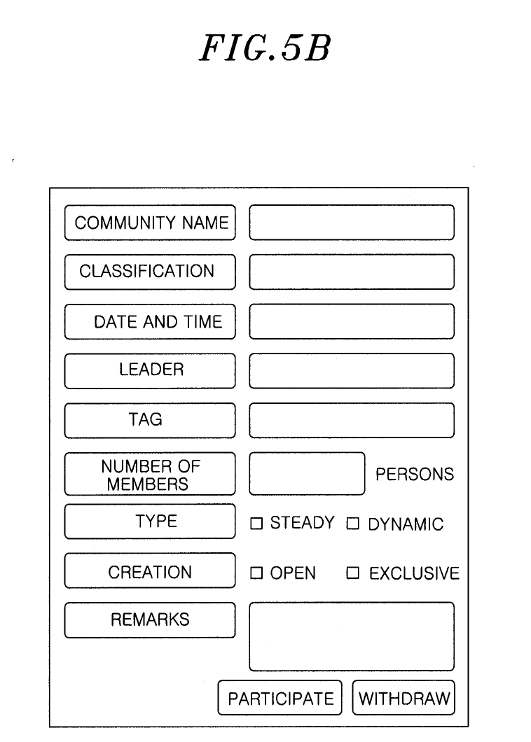

In addition, a “Comm_Tag field is a field into which information is inputted such that a related tag is inputted to search for a corresponding digital community easily searched for and [Comm_Lifecycle] field defines lifecycle of the created digital community. A creator of the digital community, for example as illustrated in FIG. 5A, may set conditions of automatically deleting the corresponding digital community (dynamic) through a community create/delete interface when a user is out of a preset location or of maintaining the corresponding digital community even when the user is out of the preset location (steady). The conditions are to prevent an infinite number of created digital communities from existing or a digital community to be maintained from being deleted by an arbitrary movement. Moreover, [Comm_Mode] field is for opening a digital community created by a corresponding user or for prohibiting a certain user from accessing the corresponding digital community by excluding the corresponding digital community. This field may restrict social relation but may be flexibly used according to community creator's intend.

Here, a digital community may be created by considering various conditions such as location relation information, social relation information, and interests of members (concerning field), wherein the social relation means relation such as relatives, family, colleagues, alumni/alumnae, and neighbor.

Next, when user location information and keyword for searching for a community are provided from a certain user terminal, the community searching block 1044 searches for a digital community related to the key word in the digital community profile DB 106 and provides the searched result to a corresponding user terminal. Thus, each of users who enter a preset location range (or a preset region) may participate in desired one or plural of the digital communities as a member thereof, and then may be provided with a community execution service such as a chatting service, a video call service, and location finding service. Consequently, desired information may be obtained or trouble may be solved in cooperation with several members.

Moreover, the community searching block 1044 provides a recommending service about a digital community by considering a location relation, personal feature, and the like. For example, if a user goes a baseball stadium to see a baseball game, personal feature of the user is analyzed and a community (for example, New York Yankee's supporters) related to a baseball team matched to the personal preference is recommended among communities related two baseball teams which play a baseball game currently (for example, New York Yankee's supporters and Boston Red Sax's supporters).

The community reconstructing block 1046, when a user terminal provides user profile for joining at least one digital communities that are contained in the search result for the digital communities, reconstructs a corresponding digital community by updating information of a new member who makes a request for membership to provide a function of allowing the corresponding user to join the corresponding digital community as a member. That is, users, for example, may be provided with a participation (join) and withdrawal service in and from a desired digital community through a community join/withdrawal interface as illustrated in FIG. 5B. Here, a user may join (participate) one or plural digital communities.

The community service block 1048 provides the community execution service, for example, a chatting service, a video call service, and a location finding service to respective members (including the community creator) who participate respective digital communities that are created and registered in the digital community profile DB 106.

Finally, the member management block 110 manages information about the respective members who join the respective digital communities that are registered in the digital community profile DB 106. The information of the members includes, for example, the following information.

Community Profile
Create a table for storing profile of a community
Created on every community independently

Community User List
Create user tables of respective communities
Created on every community independently

Community Tag List
Create a related tag list management table of every community
Add a tag inputted when a user joins

User Community List
User-joined community list management table

Moreover, the member management block 110 provides additional service of automatically withdrawing a specific member who participates in a specific digital community when the member gets out of a preset location range and of generating an automatic withdrawal guide message corresponding to the automatic withdrawal to provide (inform) to the creator of the specific digital community when the specific member is automatically withdrawn.

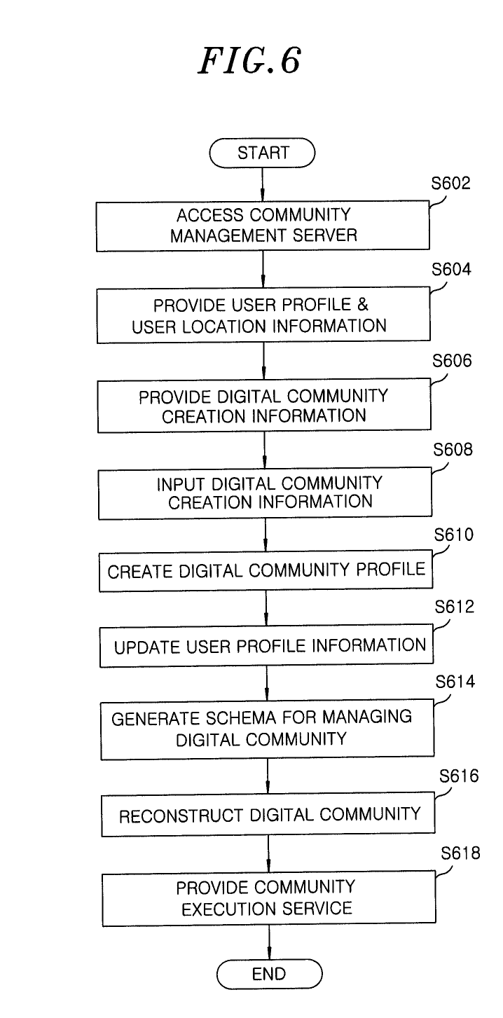

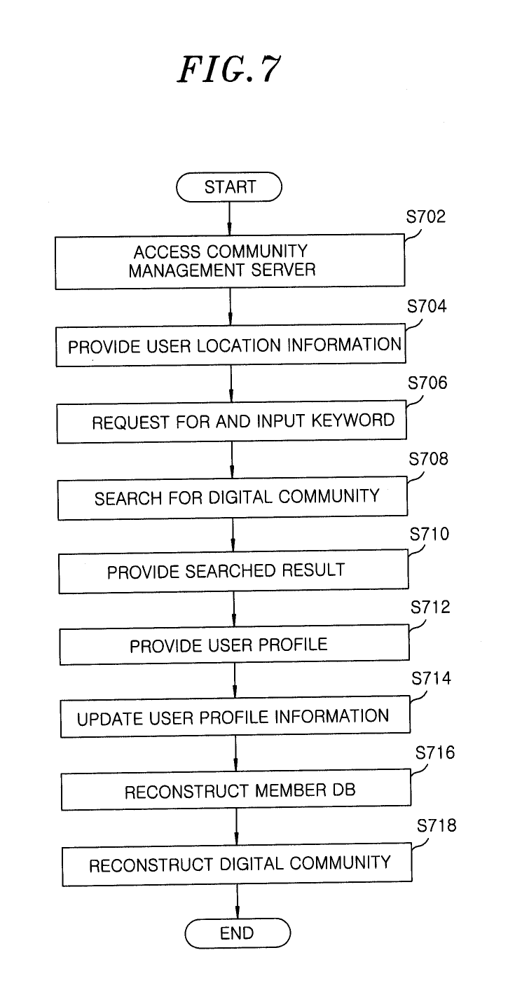

Next, a series of processes of providing a dynamic management service for a digital community using the location and social relation-based dynamic digital community management system in accordance with the embodiment of the present invention as described above will be described in detail with reference to FIGS. 6 and 7.

FIG. 6 is a flow chart illustrating process of creating a dynamic digital community in accordance with an embodiment of the present invention.

Referring to FIG. 6, a certain user (user terminal) accesses a community management server through a wireless network in step S602 and transmits a user profile and user location information (for example, a GPS value of the user terminal or an IP value of the wireless LAN to which the user terminal accesses) stored in the user terminal to the community management server to request for creation (registration) of a digital community in step S604. The user may be a member who is already joined as a community service member and in this case, the access to the community management server may be login access.

Next, the community management server provides an interface of inputting information for community creation to the user terminal which requests for creation of a digital community, for example, provides an interface screen for creation of a digital community, as illustrated in FIG. 5A, to the user terminal and waits for input of information on the digital community creation in step S606).

Thus, a user may input desired information in respective items (fields) such as a community name, classification, creation date, leader, related tags, type, creation, and remarks or input information on the digital community creation by selecting items. In this case, when the information on the digital community creation is inputted, the community management server builds (constructs) a profile database of a new digital community and adds the new digital community into a community list in step S610.

Then, when the user creates a specific digital community, the information of a digital community created in the user profile that is stored in the user profile database 108 is updated in step S612 and a database schema for managing a dynamic digital community is generated, that is, an information initiation job of generating for the management of several members who will join after that is performed in step S614. Here, the information initiation job includes creation of data structure for storing and managing information of the new members and a related database.

After that, the community management server reconstructs the added digital community and corrects information on the digital community list such that a certain user searches for the newly created digital community or participates in the same as a member in step S 616. Thus, location and society related many and unspecified users may search for or participate in the newly registered digital community using the personal feature and may be provided with the community execute service such as a chatting service, a video call service, and a location finding service in step S618.

On the other hand, although not illustrated in FIG. 6, the method of the present invention may be set to delete a specific digital community from a community list when a creator of a specific digital community is out of a preset local range. In this case, the deletion of a digital community may be set such that the creator of the digital community selects the digital community to be deleted and also may be set such that the deletion of the specific digital community is guided to respective existing members when the specific digital community is deleted when to create a specific digital community and to.

Moreover, when a creator of a specific digital community departs from the preset location range, the method of the present invention may be set to create a location departure guide message corresponding to the departure while maintaining the specific digital community to the creator. In this case, the maintenance of the specific digital community may be set for the community creator to select when to create the specific digital community.

In addition, when a specific member who participates as a member of a specific digital community departs from the preset location range, the method of the present invention may be also set to automatically withdraw the specific member from the specific digital community and to create an automatic withdrawal guide message corresponding to the departure to provide the creator of the specific digital community.

FIG. 7 is a flow chart illustrating a main process of joining a created dynamic digital community as a member in accordance with an embodiment of the present invention.

Referring to FIG. 7, a certain user (user terminal) accesses the community management server through the wireless LAN in step S702) and transmits user location information, such as a GPS value of the user terminal or an IP value of the wireless LAN to which the user terminal accesses, stored in the user terminal to and requests the community management server for searching for a digital community in step S704. In this case, the user may be a member who has been registered as a community service member and then the access to the community management server may be login access.

In response to that, when the community management server requests the user terminal for searching for a keyword, the user inputs the keyword for searching for a desired digital community, for example one or plural keywords in step S706.

Next, the community management server searches for a digital community related to the keyword provided by the user by searching the digital community profile DB 106 in step S708 and provides the searched result to the user terminal in step S710.

When a user provides the user profile that is stored in the user terminal for joining in (participate in) at least one digital communities included in the searched result to the community management server in step S712, the community management server updates the user profile (registers the user profile in the user profile database 108) by inputting information of the digital community which the user wishes to join in step S714.

The community management server inputs a newly added user as a member by reconstructing of members of a digital community which the user wishes to join again in step S 716 and reconstructs the digital community by informing updated information of the newly joined member to existing members of the digital community in step S718. Thus, the newly joined user of the digital community may receive the community execution service like the existing members.

Meanwhile, although not illustrated in FIG. 7, the method of the present invention may be set to create a message of guiding a newly joining as a member of a digital community when a new member joins the digital community and to provide the created message to the creator of the digital community.

While the invention has been shown and described with respect to the embodiments, it will be understood by those skilled in the art that various changes and modifications may be made without departing from the scope of the invention as defined in the following claims.

What is claimed is:

1. A system for managing a dynamic digital community based on location and social relations, comprising:
a user location information collecting block configured to analyze user location information provided by a user terminal and provide a location searching function of searching for where the user terminal is;
a community lifecycle management block configured to provide a service for creating and deleting a digital community, a service for joining a digital community as a member and withdrawing from the digital community, and a community execution service to user terminals based on the user profile and the user location information that are provided by the user location information collecting block;
a digital community profile database configured to store community profiles about respective digital communities that are created by the community lifecycle management block;
a user profile database configured to store user profiles of respective members who join the respective digital communities that are registered in the digital community profile database and creators of the respective digital communities; and
a member management block configured to manage information of the respective members who join the respective digital communities registered in the digital community profile database.

2. The system of claim 1, wherein the community lifecycle management block comprises:
a community creating block configured to create a digital community with the user terminal as a creator of the digital community based on the user profile and the user location information that are provided by the user terminal;
a community searching block, when the user location information and a keyword for searching for a community are provided from the user terminal, configured to search the digital community profile database for a digital community related to the keyword and provide the searched result to the user terminal;
a community reconstructing block, when the user terminal provides the user profile for joining at least one digital communities included in the searched result, configured to reconstruct a corresponding digital community by updating information of a member who makes a request for a membership to allow the user terminal to join as a new member; and
a community service block configured to provide the community execution service to members joined in the respective digital communities that are registered in the digital community profile database.

3. The system of claim 2, wherein the community execution service comprises at least one of a chatting service, a video call service, and a location finding service.

4. The system of claim 1, wherein the user location information comprises one of a GPS value of the user terminal and an IP value of a wireless LAN to which the user terminal accesses.

5. The system of claim 1, wherein, when the creator of the digital community is out of a certain location range, the community lifecycle management block deletes the digital community from the digital community profile database.

6. The system of claim 1, wherein, when a specific member who participates in a specific digital community is out of a certain location range, the member management block automatically withdraws the specific member from the specific digital community.

7. The system of claim 6, wherein, when the specific member is automatically withdrawn, the member management block creates an automatic withdrawal guide message and provides the created automatic withdrawal guide message to a creator of the specific digital community.

8. A method for managing a dynamic digital community based on location and social relations, comprising:
providing a user profile and user location information to a community management server by a user terminal to request for creation of a digital community;
requesting the user terminal for input of community creation information for creating the digital community;
building a profile database of a new digital community based on the community creation information that is provided from the user terminal and registering a new digital community which a user may search for and join in a community list; and
providing a community execution service with respect to the newly registered digital community.

9. The method of claim 8, wherein said registering the new digital community comprising:
building the profile database of the new digital community based on the community creation information;
updating information on a digital community generated in a user profile database;
generating a database for managing a plurality of users who join additionally to initialize corresponding information of the generated database; and
registering the new digital community which a user searches for and joins in the community list.

10. The method of claim 8, wherein the user location information comprises one of a GPS value of the user terminal and an IP value of a wireless LAN to which the user terminal accesses.

11. The method of claim 8, further comprising deleting a specific digital community from the community list when a creator of the specific digital community is out of a preset location range.

12. The method of claim 11, wherein said deleting the specific digital community is set such that the creator of the specific digital community selects the digital community to be deleted when the specific digital community is created.

13. The method of claim 11, further comprising guiding respective existing members the deletion of the specific digital community when the specific digital community is deleted.

14. The method of claim 8, further comprising creating a location departure guide message while maintaining a specific digital community when a creator of the specific digital community is out of a certain location range and providing the created location departure message to the creator.

15. The method of claim 14, wherein said maintaining the specific digital community is set such that the creator of the specific digital community selects the digital community to be maintained when the specific digital community is created.

16. The method of claim 8, further comprising automatically withdrawing a specific member from a specific digital community when the specific member who participates in the specific digital community is out of a certain location range.

17. The method of claim 16, further comprising creating an automatic withdrawal guide message to provide the created automatic withdrawal guide message to a creator of the specific digital community when the specific member is automatically withdrawn.

18. The method of claim 8, wherein the community execution service comprises at least one of a chatting service, a video call service and a location finding service.

19. A method for managing a dynamic digital community based on location and social relations, comprising:
requesting a community management server for searching a digital community related to a location by providing user location information and a keyword from a user terminal to the community management server;
searching a digital community profile database for the digital community related to the keyword and providing the searched result to the user terminal;
determining joining in at least one digital community included in the searched result by the user terminal and providing a user profile to the community management server from the user terminal;
allowing the user terminal as a member of the digital community in which the user terminal determines to join by reconstructing the digital community in which the user terminal determines to join by reconstructing a database of members of the digital community in which user terminal determines to join and updating information on a newly joined member; and
providing a community execution service to the user terminal which newly joined as a member of the digital community in which user terminal determines to join.

20. The method of claim 19, further comprising creating a message of guiding to join a digital community as a new member to provide the created message to a creator of the digital community in which the new join is determined.
